(19) United States
(12) Patent Application Publication
(10) Pub. No.: US 2024/0182666 A1
(43) Pub. Date: Jun. 6, 2024

(54) Method For The Production Of A Polyhydric Alcohol From A Urethane Containing Polymer

(71) Applicant: loniqa Technologies B.V., Eindhoven (NL)

(72) Inventors: Luuk Lambertus Christina OLIJVE, Eindhoven (NL); Andre Banier DE HAAN, Eindhoven (NL); Joost Robert WOLTERS, Eindhoven (NL)

(73) Assignee: loniqa Technologies B.V., Eindhoven (NL)

(21) Appl. No.: 18/286,342

(22) PCT Filed: Apr. 14, 2022
(86) PCT No.: PCT/NL2022/050206

§ 371 Date: Oct. 10, 2023

(30) Foreign Application Priority Data
Apr. 16, 2021 (NL) 2028001

(51) Int. Cl. C08J 11/24

(52) U.S. Cl. CPC C08J 11/24; C08J 2375/04

(57) ABSTRACT

A method is described for the production of a polyhydric alcohol from a urethane containing polymer. The method first provides a reaction mixture comprising said polymer, a reactive solvent, which comprises a polyol; and a catalyst, comprising catalyst particles. Said polymer is depolymerized in said reaction mixture by reacting with said polyol to produce said polyhydric alcohol. A further step allows said reaction mixture containing said polyhydric alcohol product to separate into a product phase containing said polyhydric alcohol and another phase mainly containing said polyol and said catalyst. The catalyst is recovered from said another phase, while said polyhydric alcohol product is recovered from said product phase. The catalyst is a catalyst complex comprising the catalyst particles and a catalyst entity covalently bonded to the catalyst particles via a linking group, wherein the catalyst entity comprises a cationic moiety having positive charge and a negative moiety having negative charge.

### FIELD OF THE INVENTION

The present invention relates to a method for the production of a polyhydric alcohol from a urethane containing polymer. Said urethane containing polymer is a homopolymer or copolymer containing a urethane structural unit.

### BACKGROUND OF THE INVENTION

There is an increasing awareness that the large amount of polymers used nowadays for a variety of purposes should be recycled in order to prevent an increasing amount of polymer waste. Incineration is one possibility, however undesirable for obvious reasons. Mechanical shredding and milling of used polymers may be another solution to the problem of accumulating polymer waste. However, the recycled polymer properties are then degraded and they frequently end up as filler for other materials. Circular recycling (chemical recycling) is clearly the solution of choice. In circular recycling, the polymer to be recycled is depolymerized into its building blocks, such as the repeating units from which the polymer is made. The repeating units resulting from the degradation reaction may be used again in making a new polymer.

Degradation of used polymers may be hindered by the fact that such polymers are typically present in a product that may contain a plurality of materials, and suitable separation methods should be provided for separating the polymer to be recycled from the product. As a consequence a significant amount of used polymers is still used as a fuel, which is burned.

A further difficulty seems to be assuring a consistent and continuous waste sourcing, such as fibers, films, bottles, foams and textiles for instance, in a required extensive amount at one single site. Yet a further issue may be that, even when the problem of separation of the desired polymer to be recycled from a product has been solved satisfactorily, the process of degradation of the polymer into smaller repeating units, such as its repeating units, has proven to be difficult. Many known methods are not selective enough, or are deficient in terms of a too low conversion. An efficient conversion of the polymers to the desired products (repeating units and/or oligomers) is desirable, at the same time minimizing production of waste in terms of side products. In other words, a relatively high yield (selectivity times conversion) is a desirable goal in depolymerization methods.

Polyurethane homo- and copolymers are widely used nowadays. They are typically used into a variety of intermediate articles such as foams, chips, films, and/or end products such as fabrics, insulation articles and foam articles. The processing of polyurethane (co)polymers into intermediate articles and end products results in a huge amount of polyurethane processing waste.

PU foam typically consists of from 30-40 wt. % of diisocyanate, such as toluene diisocyanate (TDI), and from 60-70 wt. % of a polyhydric alcohol. The specific combination of the diisocyanate/polybydric alcohol and the polyhydric alcohol properties largely determine the polyurethane (PU) foam properties. Currently, mechanical recycling of PU foam is mainly used in applications such as bonded foam or in downcycling of insulation material. A linear chemical recycling method is also known. In such a linear recycling method, as disclosed in U.S. Pat. Nos. 5,300,530 and 5,357,006 for instance, a glycolysis is performed and the reaction mixture is further processed by propoxylation or by adding glycidyl ether to reduce in particular OH number and toxic aromatic amine by-products. In general, a “dark colored viscous fluid” polyhydric alcohol recyclate is obtained from the linear approach, and the product is not equal to ‘virgin’ polyhydric alcohol. It is therefore used for other less demanding applications such as lower-grade products and rigid foams. In addition to the brown color typically obtained and the undesirable presence of toxic aromatic diamines, residual catalyst and/or other metal/salts and/or glycol may remain in the polyhydric alcohol, which can affect foaming properties. The polyhydric alcohol recyclate has a (too) high viscosity for satisfactory further processing.

Circular recycling methods, such as disclosed in U.S. Pat. No. 5,605,935, have also been attempted for polyurethane. Such methods aim at depolymerizing waste polyurethane materials back to the polyhydric alcohol monomer, which polyhydric alcohol monomer is equal or similar to virgin polybydric alcohol and may then be reused in forming polyurethane again by polymerization. Preferably, the polyurethane has properties similar to virgin polyurethane materials, such that it may be used in flexible (soft) foam products for instance.

In general, polyurethane is depolymerized at elevated temperatures, usually in the presence of a homogeneous catalyst. Although the polyhydric alcohol yield of the known process is acceptable, there is a need in the industry for an improved method for the depolymerization of polyurethane processing waste.

Therefore, it is an aim of the present invention to provide a circular recycling method for waste polyurethane products at satisfactory yield. A further aim is to provide a recovered polyhydric alcohol that has a demonstrated polyhydric alcohol quality almost equal or equal to virgin polyhydric alcohol. This allows the recovered polyhydric alcohol to be used in producing flexible foam products for instance that cannot be distinguished from virgin products. Obviously, the recovered polyhydric alcohol may also be used for producing down-cycled products such as rigid foam.

### SUMMARY OF THE INVENTION

The invention thereto provides a method in accordance with claim 1. A method for the production of a polyhydric alcohol from a urethane containing polymer is provided that comprises the steps of:
a. providing a reaction mixture comprising:
   i. said polymer, which comprises a urethane structural unit;
   ii. a solvent, which comprises a polyol capable of reacting with said polymer to depolymerize said polymer; and
   iii. a catalyst, which comprises catalyst particles;
b. depolymerizing said polymer in said reaction mixture by reacting with said polyol to produce said polyhydric alcohol;
C. allowing said reaction mixture containing said polyhydric alcohol product to separate into an, upper, product phase containing said polyhydric alcohol and another, lower, phase mainly containing said polyol and said catalyst;
d. recovering the catalyst from said another phase; and
e. recovering said polyhydric alcohol product from said product phase;

wherein the catalyst is a catalyst complex comprising the catalyst particles and a catalyst entity covalently bonded to the catalyst particles via a linking group, wherein the catalyst entity comprises a cationic moiety having a positive charge and a negative moiety having a negative charge.

The prior art method uses homogeneous catalysts such as small amounts of a tertiary amine or tin carboxylate to depolymerize the polyurethane. The waste polyurethane is recycled into polyhydric alcohols by a glycolysis reaction. The polyurethane, for instance in the form of a foam, is typically provided into relatively small particles and mixed with a glycol or a mixture of glycols, such as propylene glycol, dipropylene glycol, diethylene glycol and the like. The glycolysis is carried out at high temperatures, for instance at temperatures of between 180ºC and 220° C., where the foam is rapidly dissolved into the liquid reaction mixture. Urethane links between the isocyanate and the polyhydric alcohol are attacked by the glycol. Also, a transurethanation may occur that re-establishes a polyurethane bond with the glycol and liberates the original polyhydric alcohol. Polyurethane with reduced molecular weight is hereby obtained. The urethane and possibly also urea bonds may be attacked by the glycol to form a urethane with the glycol and an amine. In TDI or methylenediphenyl diisocyanate (MDI) based polyurethanes, the amines liberated comprise primarily oligomeric aromatic amines. Also, some free diamines may be formed depending on the polyurethane product and process conditions.

The method in accordance with the invention at least partly avoids disadvantages of the known method. It provides a circular recycling process and yields a recovered polyhydric alcohol of almost equal or equal quality as virgin polyhydric alcohol. The invented method in short proposes a so-called split-phase glycolysis using a solvent, which comprises a polyol capable of reacting with said polymer to depolymerize said polymer and a catalyst being a catalyst complex comprising catalyst particles and a catalyst entity covalently bonded to the catalyst particles via a linking group, wherein the catalyst entity comprises a cationic moiety having a positive charge and a negative moiety having a negative charge. Providing the reaction mixture preferably comprises dissolving the polyurethane in the solvent of the reaction mixture.

After glycolysis, the reaction mixture is separated into a non-polar upper phase (hydrophobic polyhydric alcohol) and a polar lower phase (solvent, catalyst and byproducts). The split-phase process has turned out to be specific to more than 80% polyether-based polyhydric alcohols, such as propylene oxide (PPO)-based polyhydric alcohol.

The invented method distinguishes from known methods in at least one of: (1) the type of heterogeneous catalyst used and its optional magnetic recovery; (2) the type of polyol reactant; (3) the polyurethane/polyol reactant ratio used, for instance 10:30; and (4) the optional purification step, performed in an embodiment by adding methyl-tert-butylether (MTBE) co-solvent to the recovered polyhydric alcohol and extraction with a 50/50 vol % mixture of 0.1 M hydrogen chloride (HCl) in water and polyol, for instance ethylene glycol (EG).

The invented method yields an improved quality recovered polyhydric alcohol product. Relevant specifications for recovered polyhydric alcohol among others comprise:
Color (should be colorless, “water-white”)
OH number (hydroxyl functionality, chain length, residue glycol; affects foam properties)
Acidity (influences the OH number determination)
Brookfield viscosity
Water content (influences foam behavior)
Trace metals (Na, K, Ca, Sn, etc., influences foaming behavior)
Smell (produced foam must not contain a strong solvent smell, or harmful VOCs)

The polyhydric alcohol recovered from the invented method performs particularly well with regard to the above specifications, as will be apparent from the experimental disclosure given further below.

According to an embodiment of the invention, a method is provided wherein said polyol capable of reacting with said polymer is selected from the group consisting of ethylene glycol, diethylene glycol and glycerol.

The weight ratio of polyol to urethane containing polymer may be chosen according to the reaction conditions and the properties of the urethane containing polymer and the polyol. Preferred embodiments relate to methods wherein a weight ratio of said polyol to said urethane containing polymer is from 5 to 50, preferably from 10 to 45, more preferably from 10 to 30, and most preferably from 20 to 40.

In other embodiments, methods are provided wherein a molar ratio of said polyol to said urethane structural unit of the polymer is from 3 to 20, preferably from 5 to 15, more preferably from 10 to 12.

In yet other embodiments of the invention, methods are provided, wherein said separating step c. comprises adding a co-solvent to the reaction mixture, wherein said co-solvent has a relative polarity lower than the relative polarity of the polyol reacting solvent.

The relative polarity of the co-solvent is preferably at most 0.2, preferably is in the range of 0.1-0.2. Relative polarity is defined against the polarity of water of which the relative polarity is 1. The values for the relative polarity are normalized from measurements of solvent shifts of absorption spectra and were extracted from Christian Reichardt, Solvents and Solvent Effects in Organic Chemistry, Wiley-VCH Publishers. 3rd ed., 2003. Suitable co-solvents comprise ethyl tert-butyl ether (ETBE) and other tert-butyl ether types, with a relative polarity around 0.1-0.2. The preferred methyl tert-butyl ether (MTBE) has a relative polarity of 0.124. The tert-butyl group may prevent the formation of (potentially explosive) peroxides. Suitable co-solvents may also comprise diethyl ether and other alkyl/aryl ethers; halogens such as chloroform, chlorobenzene, although less desirable; aromatics such as benzene, toluene, xylene, although some may be objectionable due to being restricted substances/carcinogenic; hydrocarbons such as pentane; esters such as ethyl acetate (EtOAc), ethyl benzoate and other non-polar esters, although esters may hydrolyse in acidic environments; ketones such as methyl isobutyl ketone (MIBK), 2-pentanone and cyclohexanone; and alcohols such as 1-butanol, tert-butyl alcohol, pentanol or cyclohexanol. The latter generally have a relatively high polarity and may be less desirable due to their relatively high boiling point. Particularly preferred co-solvents comprise green alternatives for methyl-tert-butylether (MTBE), such as 2-methyltetrabydrofuran or cyclopentyl methyl ether for instance.

In yet other embodiments of the method, the recovering step of the polyhydric alcohol product comprises extracting the polyhydric alcohol product from the upper product phase using an extracting solvent mixture comprising ethylene glycol and a water phase.

The volume ratio of said ethylene glycol to said water phase is preferably 10:90 to 90:10, and more preferably 25:75 to 75:25.

In a particularly preferred method, the water phase contains hydrogen chloride (HCl), preferably in a molar amount of at least 0.05 M, in particular in a molar amount of at most 1.00 M.

According to embodiments of the invented method, the depolymerizing step comprises maintaining the water amount in the reaction mixture below 3 wt %, preferably below 2 wt %, with respect to the total weight of the solvent. It has been found that by maintaining the water amount in the reaction mixture during the depolymerizing step below 3 wt %, preferably below 2 wt %, the amount of side-products, such as diamines, is reduced, in particular the amount of side-products which have a strong colour may be reduced.

The reaction temperature of the depolymerization may be chosen dependent on the type of polyurethane product and solvent. In preferred embodiments, a method is claimed wherein reaction conditions of the depolymerizing step comprise a temperature in a range of 150 to 300° C., preferably 190 to 250° ° C., more preferably 190 to 210° C.

Another preferred method according to an embodiment uses a depolymerizing step that comprises refluxing the solvent at a reflux temperature of the solvent. The solvent is preferably selected to have a reflux temperature in a range of 190 to 250° C., more preferably of 195 to 210° ° C. The refluxing process supports maintaining the temperature substantially constant and at the same time maintaining the water amount in the reaction mixture low.

The heterogeneous catalyst that is used in the invention is a catalyst complex comprising the catalyst particles and a catalyst entity covalently bonded to the catalyst particles via a linking group, wherein the catalyst entity comprises a cationic moiety having a positive charge and an anionic moiety having a negative charge. The catalyst particles are preferably nanoparticles, and more preferably magnetic (nano)particles and the latter are preferably used in a method wherein the recovering step of said catalyst is carried out using a magnetic force of attraction between a magnet and said particles. The catalyst particles in themselves may also exhibit catalytic activity.

The catalyst complex comprises three distinguishable elements: a (nano) particle, a linking group attached to the particle by a covalent bond, and a catalyst entity that is covalently bonded to the linking group. The linking group does not fully cover the nanoparticle surface, such as in a core-shell particle.

The present nanoparticle is preferably of a magnetic nature, either comprising a magnetic material, or having the ability to be magnetized sufficiently under relatively modest magnetic fields, such as being applied in the present method. Suitably, the magnetic nanoparticles contain an oxide of iron, manganese and/or cobalt, or combinations thereof. Iron oxide, for instance but not exclusively in the form of Fe₃O₄ is preferred. Another suitable example is CoFe₂O₄.

The particles may comprise one or substantially one (chemical) element, such as iron, cobalt, manganese, etc., but may also comprise particles having a metal ion and a counter ion, such as oxygen, boron and nitrogen. Also combinations, such as alloys, mixed particles, and the like are applicable. In a preferred method, the catalyst particles comprise a transition metal oxide, preferably an iron oxide, more preferably a ferrite such as hematite (Fe₂O₃), magnetite (Fe₃O₄), and maghemite (Fe₂O₃, γ-Fe₂O₃).

It has been found that the nanoparticles should be sufficiently small for the catalyst complex to function as a catalyst, therewith degrading the polyurethane into smaller units, wherein the yield of these smaller units, and specifically the monomers thereof, is high enough for commercial reasons. It has further been found that the nanoparticles should be sufficiently large in order to be able to reuse the present complex by recovering the present catalyst complex. It is economically unfavorable that the catalyst complex would be removed with either waste or degradation product obtained. Suitable nanoparticles have an average diameter of 2-500 nm. It is preferred to use nanoparticles comprising iron oxide. The catalyst entity, being selected, can then be attached to the present magnetic nanoparticles.

In an example of the present catalyst complex the magnetic particles have an average diameter of 2 nm-500 nm, although larger particles may be used. Preferred sizes range from 3 nm-100 nm, more preferably from 4 nm-50) am, such as from 5-10 nm. It has been found that e.g. in terms of yield and recovery of catalyst complex a rather small size of particles of 5-10 nm is optimal. It is noted that the term “size” relates to an average diameter of the particles, wherein an actual diameter of a particle may vary somewhat due to characteristics thereof. In addition aggregates may be formed e.g. in the solution. These aggregates typically have sizes in a range of 50-200 nm, such as 80-150 nm, e.g. around 100 nm.

Particle sizes and a distribution thereof can be measured by light scattering, for instance using a Malvern Dynamic light Scattering apparatus, such as a NS500 series. In a more laborious way, typically applied for smaller particle sizes and equally well applicable to large sizes representative electron microscopy pictures are taken and the sizes of individual particles are measured on the picture. For an average particle size, a number weight average may be taken. In an approximation the average may be taken as the size with the highest number of particles or as a median size.

The surface area of the catalyst particles is preferably more than 3 m²/g.

The present catalyst entity comprises at least two moieties. A first moiety relates to a moiety having a positive charge (cation). A second moiety relates to a moiety, typically a salt complex moiety, having a negative charge (anion). The negative and positive charges typically balance one another. It has been found that the positively and negatively charged moieties have a synergistic and enhancing effect on the degradation process of waste polyurethane in terms of conversion and selectivity.

In a preferred method, the cationic moiety of the catalyst entity is selected from at least one of an imidazolium group, a piperidinium group, a pyridinium group, a pyrrolidinium group, a sulfonium group, an ammonium group, and a phosphonium group. Said cationic moiety may have one ore more substituents, which one ore more substituents is preferably selected an alkyl moiety. In particular examples, said alkyl moiety has a length of C₁-C₆, such as C₂-C₄. In specific examples, said imidazolium group has two substituents R₁, R₂ attached to one of the two nitrogen atoms, respectively, said piperidinium group has two substituents R₁, R₂ attached to its nitrogen atom, said pyridinium group has two substituents R₁, R₂ wherein one of the two substituents R₁, R₂ is attached to its nitrogen atom, said pyrrolidinium group has two substituents R₁, R₂ attached to its nitrogen atom, said sulfonium group has three substituents R₁, R₂, R₃ attached to its sulphur atom, said ammonium group has four substituents R₁, R₂, R₃, R₄ attached to its nitrogen atom, and said phosphonium group has four substituents R₁, R₂. R₃, R₄ attached to its phosphor atom, respectively.

The positively charged moiety (cation) may comprise a cyclic moiety, which may be aromatic or non-aromatic. The positively charged moiety may be an aromatic moiety, which preferably stabilizes a positive charge. The cationic moiety may also be aliphatic, such as in carbamimidoylazanium (or guanidinium). Other suitable examples of aliphatic cations comprise tetrahedral phosphonium and sulphonium. The cationic moiety preferably comprises a heterocycle, having at least one, preferably at least two hetero-atoms. The heterocycle may have 5 or 6 atoms, preferably 5 atoms. Typically the cationic moiety typically carries a positive charge on the hetero-atom. The hetero-atom may be nitrogen N, phosphor P or sulphur S for instance. Suitable cationic moieties having N as hetero-atom comprise imidazolium, (5-membered ring with two N), piperidinium (6-membered ring with one N), pyrrolidinium (5-membered ring having one N), and pyridinium (6-membered ring with one N). Preferred imidazolium cationic moieties comprise butylmethylimidazolium (bmim*), ethylimidazolium, or butylimidazolium (bim⁺). Other suitable cationic moieties include but are not limited to triazolium (5-membered ring with 3 N), thiazolinium (5-membered ring with N and S), and (iso)quinolinium (two 6-membered rings (naphthalene) with N).

The negatively charged moiety (anion) may relate to a salt complex moiety, preferably a metal salt complex moiety, having a two- or three-plus charged metal ion, such as Fe³⁺Al³⁺, Ca²⁺, and Cu²⁺, and negatively charged counter-ions, such as halogenides, e.g. Cl, F, and Br. In an example the salt is a Fe³⁺ comprising salt complex moiety, such as an halogenides, e.g. FeCl₄⁻. Alternatively, use can be made of counter-ions without a metal salt complex, such as halides as known per se.

The linking group may comprise a bridging moiety for attaching the catalyst entity to the nanoparticle. The present catalyst entity and nanoparticle are combined by the bridging moiety by attaching the catalyst entity to the nanoparticle. The attachment typically involves a physical or chemical bonding between a combination of the bridging moiety and the catalyst entity on the one hand and the nanoparticle on the other hand. Particularly, a plurality of bridging moieties is attached or bonded to a surface area of the present nanoparticle. Suitable bridging moieties comprise a weak organic acid, silyl comprising groups, and silanol. More particularly, therefore, the bridging moiety comprises a functional group for bonding to the oxide of the nanoparticle and a second linking group for bonding to the catalyst entity. The functional group is for instance a carboxylic acid, an alcohol, a silicic acid group, or combinations thereof. Other acids such as organic sulphonic acids are not excluded. The linking group comprises for instance an end alkylene chain attached to the cationic moiety, with the alkylene chain typically between C₁ and C₆, for instance propylene and ethylene.

The bridging moiety is suitably provided as a reactant, in which the linking group is functionalized for chemical reaction with the catalyst entity. For instance, a suitable functionalization of the linking group is the provision as a substituted alkyl halide. Suitable reactants for instance include 3-propylchloridetrialkoxysilane. 3-propylbromide-trialkoxysilane, 2-propylchloride-trialkoxysilane, 2-propylbromide-trialkoxysilane. The alkoxy-group is preferably ethoxy, though methoxy or propoxy is not excluded. It is preferred to use trialkoxysilanes, though dialkyldialkoxysilanes and trialkyl-monoalkoxysilanes are not excluded. In the latter cases, the alkyl groups are preferably lower alkyl, such as Ci-Ca alkyl. At least one of the alkyl groups is then functionalized, for instance with a halide, as specified above.

The said reactant is then reacted with the catalyst entity. Preferably, this reaction generates the positive charge on the moiety, more particularly on a hetero-atom in the, preferably heterocyclic, moiety. The reaction is for instance a reaction of a (substituted) alkyl halide with a hetero-atom, such as nitrogen, containing cationic moiety, resulting in a bond between the hetero-atom and the alkyl-group. The hetero-atom is therewith charged positively, and the balide negatively. The negatively charged halide may thereafter be strengthened by addition of a Lewis acid to form a metal salt complex. One example is the conversion of chloride to FeCl₄.

According to the present invention, the bridging moiety and the catalyst entity bonded thereto are provided in an amount of (mole bridging moiety/gr magnetic particle) 5*10⁻⁶-0.1, preferably 1*10⁻⁵-0.01, more preferably 2*10⁻⁵-10⁻³, such as 4*10⁻⁵-10⁻⁴. It is preferred to have a relatively large amount available in terms of e.g. effective capturing and recovery of the catalyst complex, whereas, in terms of amount of catalyst and costs thereof, a somewhat smaller amount may be more preferred.

The catalyst is in preferred embodiments used in a ratio of 0.1-20 wt. %, preferably 0.5-5 wt. %, relative to the polymer weight.

### DETAILED DESCRIPTION OF PREFERRED EMBODIMENTS

The following examples illustrate various preferred embodiments of the invention. Comparative Experiments are carried out according to the state of the art.

### Examples 1-3 and Comparative Experiments a-B

### Comparative Experiment A

A 500 mL round bottom flask (RBF) was charged with 10,751 g dipropylene glycol and 0,21 g dibutyltin dilaurate (DBTDL) catalyst. The RBF was placed in a reflux set-up equipped with a condenser, overhead stirrer and an oil bath and heated to 200° C. under argon atmosphere. An amount of 10,043 gram of flexible PU foam pieces (1-2 cm³) based on polyether polyhydric alcohol with a PPO content of 88% was added and the mixing speed set to 80 RPM. After 5 h of reaction time, the reaction mixture was cooled down and collected. The resulting product was a highly viscous, dark-brown paste.

The results of this Comp Ex A are shown in Table 1 as Comp. Example A.

### Comparative Experiment B

A 500 mL round bottom flask (RBF) was charged with 10,739 g diethylene glycol and 0,008 g TI(IV)BuO catalyst. The RBF was placed in a reflux set-up equipped with a condenser, overhead stirrer and an oil bath and heated to 200° ° C. under argon atmosphere. An amount of 10,053 gram of flexible PU foam pieces (1-2 cm³) based on polyether polyhydric alcohol with a PPO content of 88% was added and the mixing speed set to 80 RPM. After 5 h of reaction time, the reaction mixture was cooled down and collected. The resulting product was a highly viscous, dark-brown paste.

The results of this Comp Ex B are shown in Table 1 as Comp Example B.

### Example 1: Imidazolium-Based Catalyst

A 1000 mL round bottom flask (RBF) was charged with 120,4 g ethylene glycol and 4.1 g of a 10.94 wt % dispersion of 1-methyl-1-(3-triethoxysilylpropyl)imidazolium Cl/Fe:04 catalyst. The RBF was placed in a reflux set-up equipped with a condenser, overhead stirrer and heating mantle and heated to reflux temperature (197° C.) under argon atmosphere. An amount of 40.2 gram of flexible PU foam pieces (1-2 cm³) based on polyether polyhydric alcohol with a PPO content of 88% was added in two portions via the side necks and the mixing speed set to 80 RPM. After 5 h of reaction time, the reaction mixture was cooled down. An amount of 120 mL of methyl-tert-butylether (MTBE) is then added to the reaction flask and the mixture is transferred to a 1000 mL separation funnel. The mixture is left overnight to phase separate. The glycol layer is discarded and the organic layer is extracted with 120 mL of 50/50 vol % 0.1 M HCl/EG (hydrogen chloride/ethylene glycol). The water/EG layer is discarded and the organic layer is dried over MgSO₄, filtered and dried under vacuum to recover the purified polyhydric alcohol as a light yellow-brown, transparent viscous oil (18.945 g, 47.1%).

The results of this Ex 1 are shown in Table las Example 1.

### Example 2: Piperidinium-Based Catalyst

A 1000 mL round bottom flask (RBF) was charged with 123,3 g ethylene glycol and 0,402 g 1-methyl-1-(3-triethoxysilylpropyl)piperidinium Cl/Fe₃O₄ catalyst. The RBF was placed in a reflux set-up equipped with a condenser, overhead stirrer and heating mantle and heated to reflux temperature (197 degrees C.) under argon atmosphere. An amount of 40.0 gram of flexible PU foam pieces (1-2 cm³) based on polyether polyhydric alcohol with a PPO content of 88% was added in two portions via the side necks and the mixing speed set to 80 RPM. After 5 h of reaction time, the reaction mixture was cooled down. An amount of 120 mL of methyl-tert-butylether (MTBE) is added to the reaction flask and the mixture is transferred to a 1000 mL separation funnel. The mixture is left overnight to phase separate. The glycol layer is discarded and the organic layer is extracted with 120 mL of 50/50 vol % 0.1 M HCl/EG. The water/EG layer is discarded and the organic layer is dried over MgSO₄, filtered and dried under vacuum to recover the purified polyhydric alcohol as a light yellow-brown, transparent viscous oil (18.424 g, 46.1%).

The results of this Ex 2 are shown in Table las Example 2.

### Example 3: Phosphonium-Based Catalyst

A 1000 mL round bottom flask (RBF) was charged with 123,1 g ethylene glycol and 0,400 g trioctyl(3-(tri-ethoxysilylpropyl)phosphonium Cl/Fe₃O₄ catalyst. The RBF was placed in a reflux set-up equipped with a condenser, overhead stirrer and heating mantle and heated to reflux temperature (197 degrees C.) under argon atmosphere. An amount of 39.9 gram of flexible PU foam pieces (1-2 cm³) based on polyether polyhydric alcohol with a PPO content of 88% was added in two portions via the side necks and the mixing speed set to 80 RPM. After 5 h of reaction time, the reaction mixture was cooled down. An amount of 120 mL of methyl-tert-butylether (MTBE) is added to the reaction flask and the mixture is transferred to a 1000 mL separation funnel. The mixture is left overnight to phase separate. The glycol layer is discarded and the organic layer is extracted with 120 mL of 50/50 vol % 0.1 M HCl/EG. The water/EG layer is discarded and the organic layer is dried over MgSO₄, filtered and dried under vacuum to recover the purified polyhydric alcohol as a light yellow-brown, transparent viscous oil (20,612 g, 51,7%).

The results of this Ex 3 are shown in Table 1 as Example 3.

TABLE 1
properties of polyhydric alcohol products

| | | | Water | | | | | | | | | | |
|---|---|---|---|---|---|---|---|---|---|---|---|---|---|
| | OH-value | Acidity | content | Trace metals XRF | | | | | | | | | |
| | (mg KOH/g) | (mg KOH/g) | (%) | (ppm) | | | | | | | | | |
| ISO/ASTM | D4274 | D4662 | 760 | NA | | | | | | | | | |
| Preferred | 28-160 | <0.1 | <0.1 | No heavy metals | | | | | | | | | |
| polyhydric alcohol | | | | | | | | | | | | | |
| for flexible PU | | | | | | | | | | | | | |
| foam | | | | | | | | | | | | | |
| Comp example A | ND | ND | ND | 2119 | Sn | 596 | Ca | 0.7 | Ti | 19 | Fe | ND | Si |
| Comp example B | ND | ND | ND | 356 | Sn | 109 | Ca | 44 | Ti | 21 | Fe | 1002 | Si |
| Example 1 | 106.0 ± 5.7 | 0.41 ± 0.01 | 0.03 | <0.3 | Sn | 28.2 | Ca | <0.3 | Ti | <2 | Fe | 1097 | Si |
| Example 2 | 103.6 ± 13.0 | 0.40 ± 0.00 | 0.1 | <0.3 | Sn | <0.8 | Ca | <0.3 | Ti | <2 | Fe | 790 | Si |
| Example 3 | 107.7 ± 1.4 | 0.39 ± 0.20 | 0.51 | <0.3 | Sn | <0.8 | Ca | <0.3 | Ti | <2 | Fe | 620 | Si |

The results in terms of specifications such as polyhydric alcohol (PH) yield, color and OH-value are shown in Table 1. Table 1 includes the ISO/ASTM norm used to measure the specification parameters. The table also indicates a preferred polyhydric alcohol range for the parameters, and typical properties of polyhydric alcohol used to produce flexible foams.

The most important trace metals for Comp Ex A were Sn (2119 ppm), Ca (596 ppm) and Fe (19 ppm), while those for Comp Ex B were Si (1002 ppm), Sn (356 ppm), Ca (109 ppm), Ti (44 ppm) and Fe (21 ppm). For Example 1, the most important trace metals were Si (1096 ppm) and Mg (59 ppm), which resulted in a substantially lower amount of trace metals for a polyhydric alcohol recovered according to the invention. The (much lower) yields for Comp Ex A and B could not be measured since too much residual remained in the flask.

### Purification Process Step

Purification of crude polyhydric alcohol of the organic layer was carried out via liquid-liquid extraction.

A depolymerization was done according to Example 1. After discarding the glycol fraction, the organic layer containing crude polyhydric alcohol and methyl-tert-butylether (MTBE) solvent was used for liquid-liquid extraction tests, with the following water and glycol solvent mixtures, respectively, as shown in Table 2:

TABLE 2
extraction tests for organic layer containing crude polyhydric
alcohol and methyl-tert-butylether (MTBE) solvent

| Extraction | | |
|---|---|---|
| test | Extraction liquid | Extraction result |
| 1 | 50/50 vol % 0.1M | immediately two layers with a clear |
| | HCl/EG | interface and a transparent top and |
| | | bottom layer. The bottom layer was |
| | | dark-red coloured while the organic |
| | | top layer was non-coloured. |
| 2 | EG | turbid organic top layer and it took |
| | | over 2 days to form two layers. |
| 3 | 50/50 vol % water/EG | yellow-coloured organic top layer. |
| 4 | Demiwater | a turbid mixture. Leaving the mixture |
| | | over 2 days did not result in de- |
| | | emulsification and the organic top |
| | | layer remained turbid. |
| 5 | Demiwater adjusted | a turbid mixture. Leaving the mixture |
| | to pH 4-5 using HCl | over 2 days did not result in de- |
| | | emulsification and the organic top |
| | | layer remained turbid |
| 6 | Saturated NaCl | a yellow-coloured organic top layer |
| | solution | |
| 7 | 50/50 vol % 0.1M | a coloured and turbid organic top |
| | HCl/saturated | layer. After over 2 days, there was |
| | NaCl solution | still emulsification visible at the |
| | | interface |
| 8 | 0.1M HCl | a turbid solution. After over 2 days, |
| | | there was still emulsification visible |
| | | at the interface. |

From the above results it is clear that the test (1) based on 50/50 volt % 0.1 M HCL/EG produced good and fast extraction of coloured side-products from the organic layer containing the polyhydric alcohol product.

A substantially pure and substantially non-colored polyhydric alcohol product may be obtained from these extraction conditions, which is usable as recovered polyhydric alcohol that has a demonstrated polyhydric alcohol quality almost equal or equal to virgin polyhydric alcohol.

From the above description, one skilled in the art can easily ascertain the essential characteristics of this invention, and may make changes and modifications to the disclosed embodiments without departing from the spirit and scope thereof, as claimed in the appended claims.

1. A method for the production of a polyhydric alcohol from a urethane containing polymer, said method comprising the steps of:
a. providing a reaction mixture comprising:
i. said polymer, which comprises a urethane structural unit;
ii. a solvent, which comprises a polyol capable of reacting with said polymer to depolymerize said polymer, and
iii. a catalyst, which comprises catalyst particles;
b. depolymerizing said polymer in said reaction mixture by reacting with said polyol to produce said polyhydric alcohol;
c. allowing said reaction mixture containing said polyhydric alcohol product to separate into a product phase containing polyhydric alcohol and another phase mainly containing said polyol and said catalyst;
d. recovering the catalyst from said another phase; and
e. recovering said polyhydric alcohol product from said product phase;
wherein the catalyst is a catalyst complex comprising the catalyst particles and a catalyst entity covalently bonded to the catalyst particles via a linking group, wherein the catalyst entity comprises a cationic moiety having a positive charge and a negative moiety having a negative charge.

2. Method as claimed in claim 1, wherein said polyol is selected from the group consisting of ethylene glycol, diethylene glycol and glycerol.

3. Method as claimed in claim 1, wherein a weight ratio of said polyol to said urethane containing polymer is from 5 to 50.

4. Method as claimed in claim 1, wherein a molar ratio of 30 said polyol to said urethane structural unit of the polymer is from 3 to 20.

5. Method as claimed in claim 1, wherein said separating step c. comprises adding a co-solvent to the reaction mixture, wherein said co-solvent has a relative polarity lower than the polarity of the polyol reacting solvent.

6. Method as claimed in claim 5, wherein the relative polarity of the co-solvent is at most 0.2.

7. Method as claimed in claim 1, wherein the recovering step of the polyhydric alcohol product comprises extracting the polyhydric alcohol product from the upper product phase using an extracting solvent mixture comprising ethylene glycol and a water phase.

8. Method as claimed in claim 7, wherein a volume ratio of said ethylene glycol to said water phase is 10:90 to 90:10.

9. Method as claimed in claim 8, wherein the water phase contains HCl.

10. Method as claimed in claim 1, wherein the depolymerizing step comprises maintaining the water amount in the reaction mixture below 3 wt %, with respect to the total weight of the solvent.

11. Method as claimed claim 1, wherein reaction conditions of the depolymerizing step comprise a temperature in a range of 150 to 300° C.

12. Method as claimed in claim 1, wherein the depolymerizing step comprises refluxing the solvent at a reflux temperature of the solvent.

13. Method as claimed in claim 12, wherein the solvent is selected to have a reflux temperature in a range of 190 to 250° C.

14. Method as claimed in claim 1, wherein the catalyst particles are magnetic particles.

15. Method as claimed in claim 1, wherein the cationic moiety of the catalyst entity is selected from at least one of an imidazolium group, a piperidinium group, a pyridinium group, a pyrrolidinium group, a sulphonium group, an ammonium group, and a phosphonium group.

16. Method as claimed in claim 1, wherein the catalyst particles comprise a transition metal oxide.

17. Method as claimed in claim 1, wherein the catalyst particles have a particle size in the range of 1 nm-50 μm.

18. Method as claimed in claim 1, wherein the catalyst particles have a surface area of more than 3 m²/g.

19. Method as claimed in claim 1, wherein the catalyst is used in a ratio of 0.1-20 wt % relative to the polymer weight.

20. Method as claimed in claims claim 1, wherein said providing step comprises dissolving the polymer in the solvent of the reaction mixture.

21. Method as claimed in claim 1, wherein the polymer is a polymer foam.
